(19) United States
(12) Patent Application Publication
(10) Pub. No.: US 2019/0240783 A1
(43) Pub. Date: Aug. 8, 2019

(54) METHOD OF MANUFACTURING A COMPONENT

(71) Applicant: ROLLS-ROYCE plc, London (GB)

(72) Inventor: Yogiraj PARDHI, Derby (GB)

(73) Assignee: ROLLS-ROYCE plc, London (GB)

(21) Appl. No.: 16/248,909

(22) Filed: Jan. 16, 2019

(30) Foreign Application Priority Data
Feb. 6, 2018 (GB) 1801901.8

(51) Int. Cl. B23K 26/342; B33Y 10/00; B33Y 40/00; B33Y 80/00; B23K 26/00; B23K 26/0622; B23K 26/06; B23K 26/073; B23K 26/14

(52) U.S. Cl. CPC B23K 26/342; B33Y 10/00; B33Y 40/00; B33Y 80/00; B22F 2003/247; B23K 26/0622; B23K 26/0626; B23K 26/073; B23K 26/1464; B23K 26/0093

(57) ABSTRACT

There is disclosed a method of manufacturing a component. The method comprises generating, by additive manufacture, an intermediate structure comprising a core corresponding to the component, and one or more excess portions to be removed and comprises machining the intermediate structure to remove the excess portions. The core is generated by a first additive manufacturing procedure and the one or more excess portions are generated by a second additive manufacturing procedure. The second additive manufacturing procedure differs from the first additive manufacture so that the excess portions are fused at a higher rate than the core.

### CROSS-REFERENCE TO RELATED APPLICATIONS

This application is based upon and claims the benefit of priority from British Patent Application Number 1801901.8 filed 6 Feb. 2018, the entire contents of which are incorporated by reference.

### BACKGROUND

### Technical Field

The present disclosure relates to a method of manufacturing a component including by generating an intermediate structure by additive manufacturing.

### Description of the Related Art

Components manufactured by additive manufacturing methods, particularly additive layer manufacturing (ALM) methods, can have significant performance and weight advantages over components manufactured by more traditional methods. The ALM technique also allows production of geometry that would be difficult, or even impossible, to achieve using other manufacturing processes. Accordingly, such manufacturing techniques are increasingly being adapted in the aerospace industry, among others.

### SUMMARY

According to an aspect, there is provided a method of manufacturing a component comprising: generating, by additive manufacture, an intermediate structure comprising a core corresponding to the component, and one or more excess portions to be removed; and machining the intermediate structure to remove the excess portions; wherein the core is generated by a first additive manufacturing procedure and the one or more excess portions are generated by a second additive manufacturing procedure which differs from the first additive manufacture so that the excess portions are fused at a higher rate than the core.

Material may be fused with a laser beam or electron beam to generate the intermediate structure. The beam may scan in a pattern corresponding to the core in the first manufacturing procedure and corresponding to the one or more excess portions in the second manufacturing procedure.

The second manufacturing procedure may have a larger beam spot size than the first manufacturing procedure. The second manufacturing procedure may have a higher beam scanning speed than the first manufacturing procedure. The second manufacturing procedure may have a larger spacing between beam scanning lines than the first manufacturing procedure. The second manufacturing procedure may have a higher beam spot intensity than the first manufacturing procedure.

The intermediate structure may be generated by powder bed additive manufacturing.

The second additive manufacturing procedure may differ from the first additive manufacturing procedure in that a layer of powder which is fused in the second additive manufacturing procedure is thicker than the layer of powder which is fused in the first additive manufacturing procedure.

The first manufacturing procedure may comprise fusing a core region of each layer corresponding to the core before depositing a further layer over the core region. The second manufacturing procedure may comprise fusing superposed excess regions of a lower layer and an upper layer, such that the excess region of the lower layer is unfused when the upper layer is deposited.

The thickness of the layer of powder which is fused in the second additive manufacturing procedure may be a multiple of the thickness of the layer of powder which is fused in the first additive manufacturing procedure.

The one or more excess portions may include a support scaffold for the core of the intermediate structure. The one or more excess portions may include a sacrificial layer surrounding for balancing residual stresses of the core of the intermediate structure.

The sacrificial layer may be generated by the second manufacturing procedure, and the support scaffold may be generated by a third manufacturing procedure. The third manufacturing procedure may differ from the second manufacturing procedure and the first manufacturing procedure so that the support scaffold is fused at a higher rate than the core and the sacrificial layer.

According to another aspect, there is provided a method of manufacturing a gas turbine engine comprising manufacturing at least one component of the engine using the method according to any preceding claim.

The present disclosure may comprise any combination of the features and/or limitations referred to herein, except combinations of such features as are mutually exclusive.

### DESCRIPTION OF THE DRAWINGS

Embodiments will now be described, by way of example, with reference to the accompanying Figures, in which:

FIG. 1 schematically shows a sectional side view of a gas turbine engine;

FIG. 2 schematically shows a sectional side view of an intermediate structure formed by additive layer manufacturing;

FIG. 3 is a flow chart showing steps of a method of additive manufacturing a component with a first and second manufacturing procedure;

FIG. 4 schematically shows a top view of the intermediate structure of FIG. 2 during manufacturing at line A-A, and beam spot sizes in a first and second manufacturing procedure;

FIG. 5 schematically shows a top view of the intermediate structure of FIG. 2 during manufacturing at line A-A, and scanning line patterns of a beam in a first and second manufacturing procedure; and

FIG. 6 is a flowchart showing steps of an example method of manufacturing a component having a first manufacturing procedure for generating a core and a different second manufacturing procedure for generating excess portions.

### DETAILED DESCRIPTION

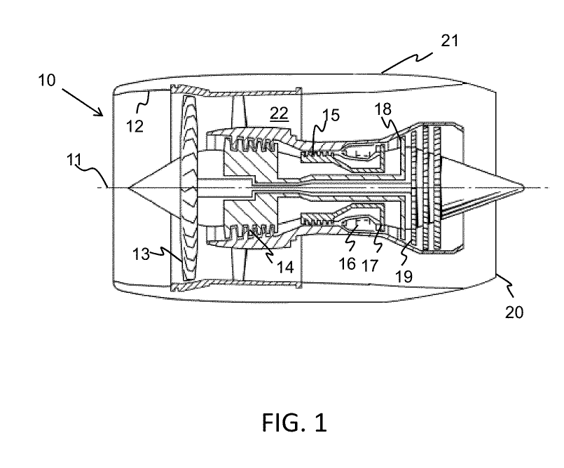

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

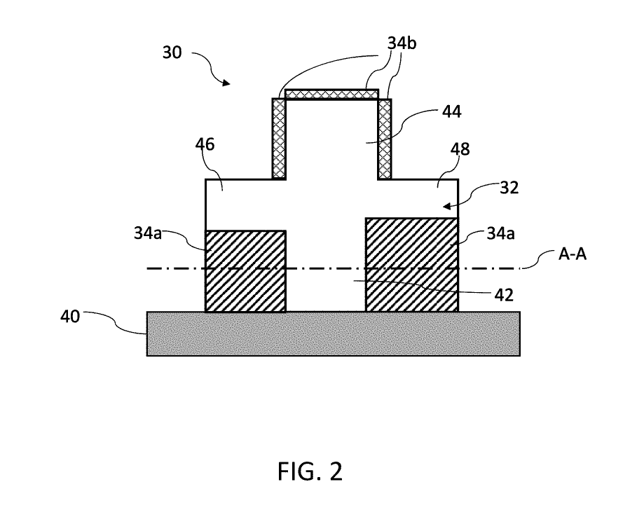

FIG. 2 shows a cross-sectional side view of an intermediate structure 30 which is formed by additive manufacture, more specifically by additive layer manufacturing, and represents an intermediate step to forming a finished component. In this example, the intermediate structure 30 is formed in a powder bed fusion process on a base plate or substrate 40. However, in other examples, the intermediate structure may be formed by any suitable additive manufacturing process.

The intermediate structure 30 comprises a core 32 corresponding to the desired component and a plurality of excess portions 34a, 34b. In this example, the cross-sectional side profile of the core 32 is substantially cross-shaped and comprises a central column having a lower column 42 and an upper column 44, with a first side portion 46 and second side portion 48, one on either side of the columns 42, 44. In other examples, the core (i.e. the component) may be of any desired shape. For example, the component may be a part for a gas turbine engine, such as a turbine blade or a guide vane.

The lower column 42 has a smaller lateral extent than the upper column 44 and the first and second side portions 46, 48 such that the side portions 46, 48 are overhanging the lower column 42, and are partially supporting the upper column 44.

During an additive layer manufacturing process to make a component, the component is built on a base plate 40 layer by layer. Therefore, in this example where there are overhanging parts in the component, scaffolds 34a are required on either side of the lower column 42, under the overhanging parts to support the overhanging parts during manufacture. The scaffolds 34a are built up from the base plate 40 to the underside of overhanging parts. These scaffolds 34a can be removed from the intermediate structure 30 by subtractive manufacturing, such as machining or grinding, when the intermediate structure has been completed.

Further, during an additive manufacturing process to make a component, powdered material is generally fused together to form the component. Examples of suitable materials include metals such as nickel alloys, titanium alloys, aluminium alloys, steel etc.

Multiple layers of powder which have been fused together can build up residual stresses in an article and may result in cracks on the surface of the article. To overcome such problems, an excess (or sacrificial) portion can be added to the core such that adverse residual stresses are focussed in the excess portion rather than the core. The excess portions can then be machined off the component to leave the component free of such adverse residual stress at its surface.

In this example, there are three sacrificial portions 34b, which are provided on each of the exposed surfaces of the upper column 44 of the core 32. These sacrificial portions 34b may be machined off the intermediate structure 30 after generation by additive manufacture. In addition, machining the intermediate structure 30 to a surface of the component may result in a lower surface roughness (i.e. a better surface finish) of the final component.

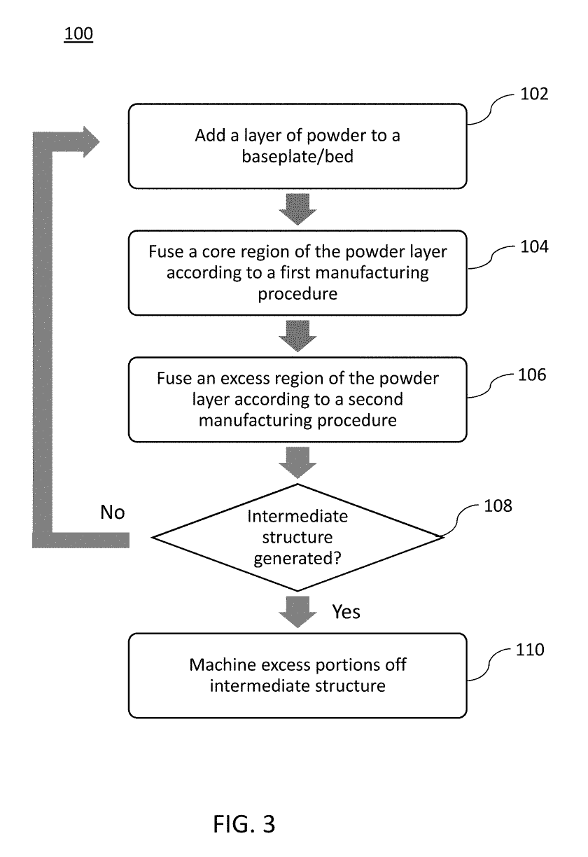

FIG. 3 is a flowchart which shows steps of a method 100 of manufacturing a component. In this method, a base plate 40 is provided on which powder can be deposited in layers. In step 102, a layer of powder is deposited on the base plate 40, and distributed to form a uniform layer. The layer of powder may be distributed with a roller which rolls over the top of the deposited powder, or by any other suitable means.

In an additive manufacturing process such as a powder bed fusion process, a heat source, which may be in the form of a laser beam or electron beam, is configured to melt the powder in the powder layer around an area of the beam, to fuse the powder together. In step 104, the beam tracks a pattern over a region which corresponds to the core 32, so as to fuse powder to form a core region in the layer of powder. In step 104, the method fuses the core region according to a first manufacturing procedure.

In step 106, the beam tracks a pattern over regions which correspond to the excess portions 34a, 34b of the intermediate structure 30 so as to fuse powder to form excess regions in the layer of powder. In step 106, the method fuses the excess regions according to a second manufacturing procedure.

The beam may track over regions of the core (“core regions”) and regions of the excess portions (“excess regions”) of the same layer in an alternating fashion, or may track over the core region and the excess regions in sequence.

In step 108, it is determined whether the intermediate structure 30 has been generated i.e. completed. If not, the method returns to step 102, and steps 102 to 106 are repeated to add another layer to the intermediate structure. This is repeated until the whole intermediate structure 30 has been generated.

Multiple layers of powder making up each of the core regions are fused together and form the core 32 of the intermediate structure 30. Multiple layers of powder making up the excess regions are fused together and form the excess portions 34a, 34b of the intermediate structure 30.

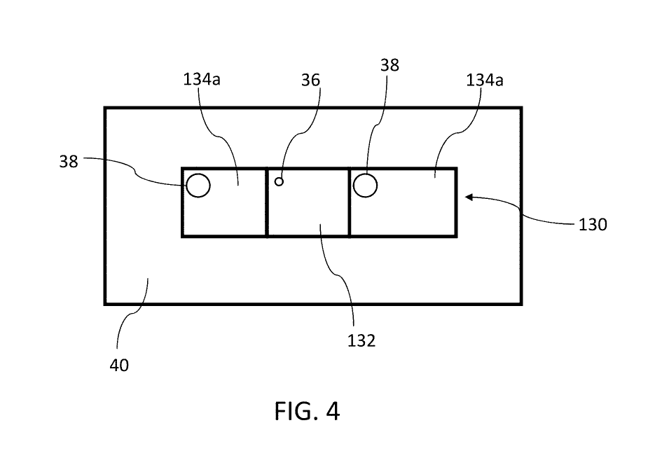

The first and second manufacturing procedures differ so that the excess portions 34a, 34b are fused at a higher rate than the core 32, thereby reducing the melt time (i.e. cumulative time taken to fuse the powder) of the intermediate structure 30 as a whole. The first and second manufacturing procedures are explained in more detail below with reference to FIGS. 4-6.

When it is determined in step 108 that the intermediate structure 30 has been generated, the method continues on to step 110 in which the intermediate structure 30 is machined to remove the excess portions 34a, 34b. Once the excess portions, including the scaffolds 34a and the sacrificial portions 34b have been removed, the finished component remains. In other examples, the method may only continue to step 110 after the intermediate structure 30 has gone through a heat treatment operation such as hot isostatic pressing. This may be to relieve residual stresses or produce a desired material microstructure.

Both the scaffolds 34a and the sacrificial portions 34b aid manufacture of the component, but do not form part of the finished component. They add to the cost and melt time of the component. Therefore, a method which increases the rate of fusion of the powder for the excess portions, as in the method described above, decreases the cost and melt time of the component.

FIG. 4 shows a top view of an intermediate slice 130 corresponding to the intermediate structure 30 of FIG. 2 during manufacture, where the fused structure has reached the level A-A shown on FIG. 2, part of the way through the lower column 42. The intermediate slice 130 at this stage comprises a core region 132 with a rectangular top cross-section, which corresponds to the core 32 in FIG. 2 up to the line A-A, and two excess scaffold regions 134a, also having rectangular top cross-sections, which correspond to the scaffolds 34a in FIG. 2 up to the line A-A. The scaffold regions 134a are disposed on either side of the core region 132.

FIG. 4 also shows a first example of how the second manufacturing procedure may differ from the first manufacturing procedure. At this stage in the manufacturing method, the intermediate structure 30 has not yet been completed, and therefore a powder layer is deposited on the powder bed according to step 102 of the method of FIG. 3.

According to step 104, a beam 36 tracks a pattern over a region which corresponds to the core 32, so as to fuse powder according to a first manufacturing procedure to form a core region in the layer of powder.

According to step 106, a beam 38 tracks a pattern over regions which correspond to the scaffolds 34a so as to fuse powder according to a second manufacturing procedure, to form the scaffolds 34a in the layer of powder.

In this example, the second manufacturing procedure differs from the first manufacturing procedure in that the spot size of the beam 38 in the second manufacturing procedure is larger than the spot size of the beam 36 in the first manufacturing procedure. This increases the rate of fusion of the powder in the second manufacturing procedure over the first manufacturing procedure, although it may tend to result in a lower quality of fused material in the excess portions 34a, 34b when compared with the core 32. However, it has been found that the material quality of the scaffolds 34a or excess (sacrificial) portions 34b is not critical to the quality of the finished component.

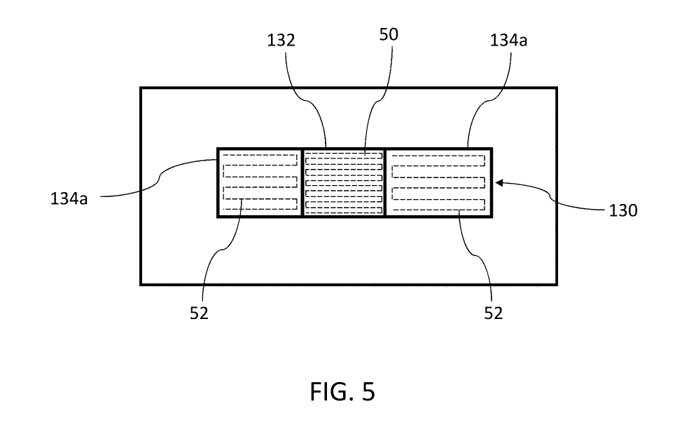

FIG. 5 shows the same view of the intermediate slice 130 as shown in FIG. 4. It shows a second example of how the second manufacturing procedure may differ from the first manufacturing procedure. As in the example described with reference to FIG. 4, the intermediate structure 30 has not yet been generated, and therefore a powder layer is deposited on the powder bed according to step 102 of the method shown in FIG. 3.

According to step 104, a beam tracks a pattern 50 (shown as a dotted line) over a region which corresponds to the core 32, so as to fuse powder according to a first manufacturing procedure to form a core region in the layer of powder.

In this example, the pattern 50 which the beam follows has a profile having a plurality of parallel scanning lines, each of which extends from one end of the core region to another end of the core region. The parallel scanning lines are spaced apart from one another, but are in close proximity, so that the material at the scanning lines and between the scanning lines in the core region is fused together into a high quality fused region.

According to step 106, a beam tracks a pattern 52 over excess regions which correspond to the excess portions of the intermediate structure 30, which at this stage are the scaffolds 34a, so as to fuse powder according to a second manufacturing procedure.

The pattern 52 which the beam follows in the second manufacturing procedure of this example also has a profile having a plurality of parallel scanning lines, each of which extends from one end of each excess region to another end of the same excess region. The parallel scanning lines are spaced further apart from one another than in the first manufacturing procedure, but are in close enough proximity so that sufficient material at the scanning lines and between the scanning lines in the excess region is fused together to form the excess portion. Therefore, the rate of fusing of the excess regions is higher than the rate of fusing of the core region. The quality of the excess region in the second manufacturing procedure may be lower as compared to the core region.

In this example, adjacent parallel scanning lines are joined together at alternating ends, so that the beam can track back and forth over each region, and does not need to be deactivated when repositioning from one scanning line to the next. However, in other examples, the parallel scanning lines may not be joined together.

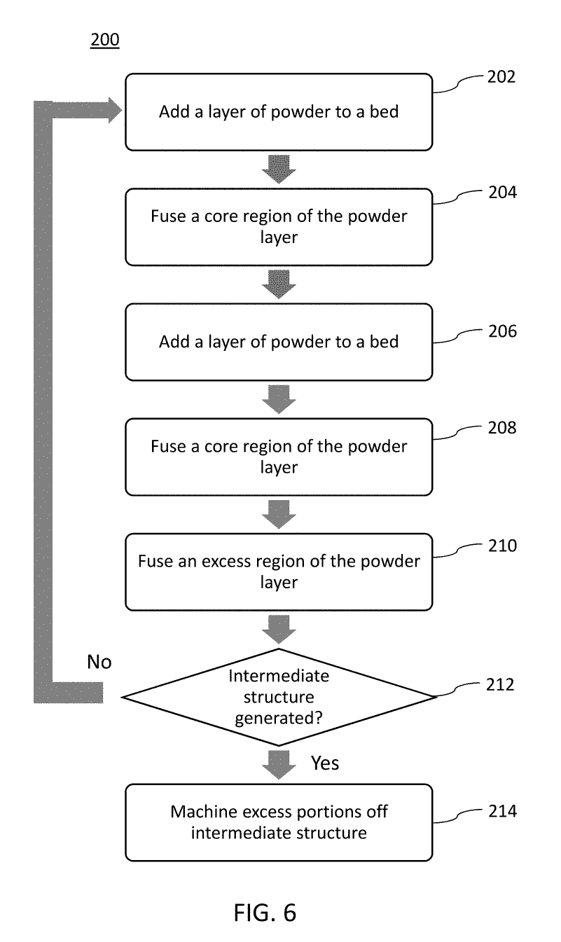

FIG. 6 shows a flowchart of an example method 200 of manufacturing a component. It shows a third example of how the second manufacturing procedure may differ from the first manufacturing procedure.

In step 202 a layer of powder is deposited on the base plate 40 as in step 102 of method 100. In step 204, a beam tracks a pattern over a core region, so as to fuse powder in a first manufacturing procedure in the same manner as in step 104 of method 100.

In step 206 another layer of powder is deposited on the powder bed without excess regions of the previous layer being fused together. In step 208, a beam tracks the pattern over the core region corresponding to the core 32, fusing the powder by the first manufacturing procedure.

In step 210, the beam tracks a pattern over excess regions which correspond to the excess portions 34a so as to fuse powder. In step 210, the method fuses the excess regions according to a second manufacturing procedure in which the two layers of powder are simultaneously fused together.

The first and second manufacturing procedures therefore differ in that the second manufacturing procedure fuses together a thicker layer of powder than the first manufacturing procedure. More specifically, in the second manufacturing procedure, two layers of powder are fused together at the same time, whereas only one layer of powder is fused together in the first manufacturing procedure. Accordingly, where excess regions of the layers are superposed, a lower layer is unfused when the upper layer is deposited, and both are fused together after depositing the upper layer.

In step 212, it is determined whether the intermediate structure 30 has been fully generated. If not, the method returns to step 202, and steps 202 to 210 are repeated to add another two layers to the intermediate slice 130. This is repeated until the whole intermediate structure 30 has been generated.

If it is determined in step 212 that the intermediate structure 30 has been generated, the method continues onto step 214. In other examples, the method may only continue to step 214 after the intermediate structure 30 has gone through a heat treatment operation such as hot isostatic pressing. This may be to relieve residual stresses or produce a desired material microstructure.

In step 214, the intermediate structure 30 is machined to remove the excess portions 34a, 34b. Once the excess portions, including the scaffolds 34a and the sacrificial portions 34b have been removed, the component has been completed.

Although it has been described that in the method 200, the second manufacturing procedure fuses two layers of powder simultaneously, in other examples, in the second manufacturing procedure, more than two layers of powder may be fused together simultaneously, such as three layers or four layers. In other words, the layer of powder fused together in the second manufacturing procedure has a thickness which is a multiple of the thickness of the layer of powder which is fused in the first manufacturing procedure.

In yet other examples, the layer of powder fused together in the second layer may have a thickness which is higher than, but not a multiple of, the thickness of the layer of powder fused in the first manufacturing procedure, such as having a thickness of one and a half times the thickness of the layer in the first manufacturing procedure.

A fourth example of how the second manufacturing procedure may differ from the first manufacturing procedure is that the beam intensity of the second manufacturing method is higher than that of the first manufacturing procedure.

A fifth example of how the second manufacturing procedure may differ from the first manufacturing procedure is that the beam scanning speed is higher in the second manufacturing procedure than in the first manufacturing procedure.

The differences between the first and second manufacturing procedure discussed in the examples above are not mutually exclusive, and therefore may be combined. For example, a second manufacturing procedure may differ from a first manufacturing procedure in that it has a beam with a higher intensity, and the beam scanning speed is faster. In other examples, a higher intensity beam may be combined with larger spacing between scanning lines, and/or a thicker layer being fused in the second manufacturing method. Yet further, the high intensity beam may be combined with both a larger beam spot size and larger spacing between scanning lines in the second manufacturing procedure.

Therefore, any combination of the examples described above may be used together in the second manufacturing method to increase the rate of fusing in the second manufacturing method.

Although it has been described that the intermediate structure is generated by generating the core according to a first manufacturing procedure and generating the excess portions according to a second manufacturing procedure, in other examples, the core may be generated according to the first manufacturing procedure, the sacrificial layer may be generated according to the second manufacturing procedure, and the scaffold may be generated by a third manufacturing procedure which is different from the first and second manufacturing procedure, in that the scaffold is generated at a higher rate than the sacrificial material.

In other examples, there may be more than two types of excess portions. In such examples, any number of the excess portions may be generated by a different manufacturing procedure which optimally generates that portion at the highest possible rate, whilst ensuring a suitable manufacturing quality for that portion. Therefore, there may be more than two, or more than three different manufacturing procedures.

We claim:

1. A method of manufacturing a component comprising:
generating, by additive manufacture, an intermediate structure comprising a core corresponding to the component, and one or more excess portions to be removed; and
machining the intermediate structure to remove the excess portions;
wherein the core is generated by a first additive manufacturing procedure and the one or more excess portions are generated by a second additive manufacturing procedure which differs from the first additive manufacture so that the excess portions are fused at a higher rate than the core.

2. A method according to claim 1, wherein material is fused with a laser beam or electron beam to generate the intermediate structure, wherein the beam scans in a pattern corresponding to the core in the first manufacturing procedure and corresponding to the one or more excess portions in the second manufacturing procedure.

3. A method according to claim 2, wherein the second manufacturing procedure has a larger beam spot size than the first manufacturing procedure.

4. A method according to claim 2, wherein the second manufacturing procedure has a higher beam scanning speed than the first manufacturing procedure.

5. A method according to claim 2, wherein the second manufacturing procedure has a larger spacing between beam scanning lines than the first manufacturing procedure.

6. A method according to claim 2, wherein the second manufacturing procedure has a higher beam spot intensity than the first manufacturing procedure.

7. A method according to claim 1, wherein the intermediate structure is generated by powder bed additive manufacturing.

8. A method according to claim 7, wherein the second additive manufacturing procedure differs from the first additive manufacturing procedure in that a layer of powder which is fused in the second additive manufacturing procedure is thicker than the layer of powder which is fused in the first additive manufacturing procedure.

9. A method according to claim 7, wherein the first manufacturing procedure comprises fusing a core region of each layer corresponding to the core before depositing a further layer over the core region; and
wherein the second manufacturing procedure comprises fusing superposed excess regions of a lower layer and an upper layer, such that the excess region of the lower layer is unfused when the upper layer is deposited.

10. A method according to claim 8, wherein the thickness of the layer of powder which is fused in the second additive manufacturing procedure is a multiple of the thickness of the layer of powder which is fused in the first additive manufacturing procedure.

11. A method according to claim 1, wherein the one or more excess portions include a support scaffold for the core of the intermediate structure.

12. A method according to claim 11, wherein the sacrificial layer is generated by the second manufacturing procedure, and the support scaffold is generated by a third manufacturing procedure; wherein the third manufacturing procedure differs from the second manufacturing procedure and the first manufacturing procedure so that the support scaffold is fused at a higher rate than the core and the sacrificial layer.

13. A method according to claim 1, wherein the one or more excess portions include a sacrificial layer surrounding for balancing residual stresses of the core of the intermediate structure.

14. A method according to claim 13, wherein the sacrificial layer is generated by the second manufacturing procedure, and the support scaffold is generated by a third manufacturing procedure; wherein the third manufacturing procedure differs from the second manufacturing procedure and the first manufacturing procedure so that the support scaffold is fused at a higher rate than the core and the sacrificial layer.

15. A method of manufacturing a gas turbine engine comprising manufacturing at least one component of the engine using the method according to claim 1.

16. A method of manufacturing a component for a gas turbine engine, the method comprising:
generating, by powder bed additive manufacture, an intermediate structure comprising a core corresponding to the component, and generating by additive manufacture one or more excess portions to be removed; and
machining the intermediate structure to remove the excess portions;
wherein the core is generated by a first additive manufacturing procedure and the one or more excess portions are generated by a second additive manufacturing procedure which differs from the first additive manufacturing procedure in that a layer of powder which is fused in the second additive manufacturing procedure is thicker than the layer of powder which is fused in the first additive manufacturing procedure.

17. A method according to claim 16, wherein the first manufacturing procedure comprises fusing a core region of each layer corresponding to the core before depositing a further layer over the core region; and
wherein the second manufacturing procedure comprises fusing superposed excess regions of a lower layer and an upper layer, such that the excess region of the lower layer is unfused when the upper layer is deposited.

18. A method according to claim 16, wherein the thickness of the layer of powder which is fused in the second additive manufacturing procedure is a multiple of the thickness of the layer of powder which is fused in the first additive manufacturing procedure.
